(19) United States
(12) Patent Application Publication
(10) Pub. No.: US 2006/0112108 A1
(43) Pub. Date: May 25, 2006

(54) Information classification and retrieval using concept lattices

(75) Inventors: Peter Werner Eklund, Wynnum (AU); Richard Jeffrey Cole, Moorooka (AU)

Correspondence Address: OSHA LIANG L.L.P., 1221 MCKINNEY STREET, SUITE 2800, HOUSTON, TX, 77010, US

(73) Assignee: Email Analysis Pty Ltd., Wollongong (AU)

(21) Appl. No.: 10/544,757

(22) PCT Filed: Feb. 6, 2004
(86) PCT No.: PCT/AU04/00137

§ 371 Date: Jan. 17, 2006

(30) Foreign Application Priority Data
Feb. 6, 2003 (AU) 2003900520

(51) Int. Cl. G06F 7/00

(52) U.S. Cl. 707/100

(57) ABSTRACT

A method and system is described for classifying and retrieving information using concept lattices. The system comprises a collection of electronic artefacts, a collection of attributes and a collection of relations associating the electronic artefacts with the attributes. The collection of attributes are arranged in a dynamic hierarchy that is dynamic and the system comprises mechanisms to consistently and scaleable update the relations between the electronic artefacts and the relations in a dynamic manner when changes in the system occur. The system further comprises a mechanism to display a subset of the electronic artefacts in a concept lattice and allow a user to easily interpret and discriminate the important attributes as they relate to the collection of electronic artefacts, relaxing or enforcing attribute search constraints depending on the volume of electronic artefacts that exists for each interacting attribute.

### FIELD OF THE INVENTION

The invention relates to a method and system for classifying and retrieving information using concept lattices. In particular the invention relates to a method and system for classifying and retrieving electronic artefacts using concept lattices. However, it is envisaged that the invention has other applications.

### BACKGROUND OF THE INVENTION

Increasingly business, organizations and individuals maintain large electronic document collections as all work and correspondence moves from pen and paper to the computer. As these document collections increase in size it becomes more difficult to locate individual documents or documents related to subjects of interest.

These document collections are often organized in computer filing systems that consist of files and drives organized within a tree structure. This organization system is derived from a metaphor of paper files and filing cabinets in which a document commonly resides within a single file, itself within a single cabinet.

This system imposes an artificial ordering over document categories as, for example, a classification scheme for e-mail must decide to either file documents first by subject, or first by author. This is an obvious deficiency because if the classification scheme is first by subject then documents cannot be retrieved if only the author is known. Most e-mail clients, for example Microsoft Outlook, and most file systems, such as NTFS and Ext3, use such a filing system.

Some recent Internet-based technologies address this problem of information classification and retrieval. These technologies are applied to the organisation and retrieval of information from document collections on the Internet. It is obvious to a person skilled in the art that the fundamentals of classification and retrieval of documents based on the Internet are the same as for document collections based on a single computer by itself or attached to a local network.

A good example of this kind of technology is the Google search engine found at www.google.com. Google is based on a vector space model. In this case, documents (Internet pages) and queries, used to search the document collection, are represented as vectors in a vector space. The document vectors are generally constructed using the frequency of terms in the content of the document as well as incorporating the importance separate documents place on each other by analysing link profiles between documents. The query vector is constructed using the query terms and using scaling factors. Documents are returned to the user in terms of a similarity measure calculated by the cosine of the angle between the search query vector and the document vectors of the collection.

Google prioritises documents based on the proximity of the search terms within documents and calculates the importance of the documents using the method discussed above in an attempt to return only documents that are most relevant to the query.

This method of classification and retrieval has deficiencies as it provides no feedback to the user regarding the relevance of the search terms used. For example, a user may enter three terms as a search query and there may exist many documents in which the first two terms are used in close proximity but few in which all three terms are used. Google will return only those documents in which all three terms appear without indicating to the user that there exists a large collection in which the first two terms appear. This information may be of value to the user and is an obvious deficiency of this form of information classification and retrieval system.

Further, there is no context sensitive hierarchy system in place in the Google classification and retrieval system. A search in Google for Casablanca will return documents related to the movie and also to the city regardless of the context in which the user intended. An information categorization and retrieval system that addresses the issues of contextually sensitive search queries is the Vivisimo search engine found at www.vivisimo.com. Vivisimo undertakes dynamic hierarchical document clustering based on the provided search query. When a query is entered a list of categories is returned to the user based on the context of the search query and the documents that exist within the collection that are relevant. If a query with terms Food and Wine are entered into Vivisimo a tree structure is returned to the user with categories such as Restaurants, Pairing, Magazines, etc. and these in turn may have further categories associated with them or documents relating to the category.

Vivisimo is a query by refinement solution to information classification as it provides the user with a way of specifying the context in which the search query was intended. It does not provide the user with the ability to compare the number of documents related to a selection of terms from within the original search query to determine search attribute relevance.

A further deficiency of the Vivisimo system is that there is no capacity to step back from the current search, remove some of the constraints placed on the document collection, and investigate another area of interest while still maintaining some context of the initial search. For the example, you are not able to further add the constraints such as Australia to the initial query and also remove the constraint Food to further limit the collection while still concentrating on one of the categories generated from the initial search. This inability to add and remove additional constraints during the retrieval process is another deficiency in the information classification a retrieval approach adopted by the Vivisimo engine.

U.S. patent application Ser. No. 09/998,682, presents a data-driven, hierarchical search and navigation system and method to enable searching of documents. This application provides the means to associate documents with attribute-value pairs and a method to search for documents based on these attribute value pairs. The system partitions the documents in the collection into domains based on natural groupings. The deficiencies in this system are that again it is a form of query by refinement as classification and retrieval of documents is limited to defined categories. Flexibility of the retrieval process is further limited by restricting the retrieval process to attribute-value pairs only.

Hence, there remains a need for individuals and organizations to have an information classification and retrieval system that provides the user with an efficient method of classifying and retrieving documents from a large collection. Further, there remains the need for an information classification and retrieval method and system that is able to discriminate key search terms by representing the number of documents that exist for all combinations of current search values and allow the user to be able to further specialise and generalise their initial search while keeping some of the context of this search. Such a system can reduce the time involved in searching for documents and increase the effectiveness of that search.

### DISCLOSURE OF THE INVENTION

In one form, although it need not be the only or indeed the broadest form, the invention resides in an information classification and retrieval system comprising:

a collection of one or more electronic artefacts;
a collection of one or more attributes;
one or more relations mapping an attribute to one or more electronic artefacts;
an arrangement of the attribute collection to form a hierarchy; and
a mechanism to consistently and scaleably modify one or more of: (i) the hierarchy, (ii) the relations, (iii) the electronic artefact collection, (iv) the attribute collection; and
a mechanism for dynamically constructing and displaying concept lattices comprising an arrangement of electronic artefacts and attributes.

Within this definition:

An electronic artefact is a collection of bits having some interpretable meaning to a person, possibly aided by a computer program such as a document browser. For example, the bits may constitute an email document, a portion of a Web page, or be a symbol by which some artefact may be retrieved, for example an ISBN or part number. The electronic artefact collection may be subject to change over time via the removal of existing electronic artefacts and the addition of new electronic artefacts.

An attribute is a symbol that may be meaningfully related to electronic artefacts by either a person or an automated process such as a computer program. The collection of attributes is subject to change over time by the addition of new attributes and the removal existing attributes.

A relation consists of a collection of associations between electronic artefacts and attributes. Each attribute may be related to one or more electronic artefacts and each electronic artefact may be related to one or more attributes. Such a relation is either;

(i) Computed on demand by some process or;

(ii) Stored in persistent and/or volatile memory via some data structure, for example an inverted file index.

In one form, a single relation, called the primary relation, is derived from one or more other relations, called the constituent relations, via a logical formula. One such derivation involves relations for; positive user judgements, negative user judgements, and keyword text retrieval. Positive user judgements arise from an indication by the user that an electronic artefact should be associated with an attribute. Negative user judgements arise from indications from the user that an electronic artefact should not be associated with an attribute. A keyword term retrieval relation indicates that an electronic artefact should be associated with an attribute because of a match between a rule expression attached to the attribute and the content or meta-data of the document. Although string search may be used to classify a text document, the technique is not limited to text documents and string search classifiers and may be extended to incorporate other classification procedures such as a neural network or a support vector machines for image, audio and video document types.

The hierarchy over the attribute collection forms either a partially ordering, or a pre-ordering. The hierarchy is “dynamic”, meaning that it may change over time. The relative ordering of attributes may change; and attributes may be deleted and added.

The primary relation is completed with respect to the hierarchy according to the following rule. If an attribute n is less than another attribute m according to the hierarchy then any document related, according to the primary relation to n, must also be related to m. The application of this rule possibly introduces new relationships between documents and attributes. The new relationships, together with the relationships of the primary relation, form the completed primary relation.

A consistent modification is one that preserves a number of constraints. For example, a modification to one of the constituent relations will result in the calculation of a completed primary relation according to the logical formula. A scalable algorithm is one whose complexity is less than O(nˆ_{1.2}) where n indicates the number of documents, attributes. This mechanism is explained in detail a later section.

A mechanism for dynamically constructing concept lattices produces a representation of a concept lattice that organises a subset of documents and attributes.

The mechanism may be activated in the following circumstances:
an expression, called a query expression, indicating properties of document to be retrieved, is input or indicated by the user;
an attribute, or collection of attributes, is indicated by the user for inclusion in a lattice diagram;
a concept is selected as the basis for a concept lattice;
an event occurs such as the receipt of new documents.

When a query expression is input or indicated by the user the system may conditionally construct new attributes and new associations between attributes and documents to the user before generating a concept lattice.

The generation of concept lattices is sensitive to contextual information in the form of a selection of attributes and concepts. Such a selection indicates that the document set included in the concept lattice should be restricted to those documents that have some (or all) of the attributes or concept intents selected.

Concept lattice diagrams may be drawn as nested line diagrams. The program will generate and display lists of documents in the extent, or object contingent, of concepts located within the diagram in response to user interaction. Concepts lattices will have attached labels displaying the number of documents in the extent or object contingent of each concept.

A data structure stores the relation between electronic artefacts and attributes. By using an interval compressed inverted file index the completed primary relation can be stored without compromising retrieval efficiency. The interval compressed inverted file index is used to generate concept lattices.

Optionally, a knowledge base or a relational database may be used to store the primary relation. As such, all relations may be stored using a knowledge base or a relational database.

Each attribute, m, has associated some subset of the other attributes, known as the scale attributes of m. The scale attributes become the attributes of the concept lattice displayed when the user indicates that the concept lattice for that attribute should be drawn. In the case that multiple attributes are indicated by the user a nested lattice is drawn. In another mode of operation a sequence of attributes may be indicated, and a combination of nesting and zooming performed to generate new concept lattices in response to user interaction.

For example, a sequence of attributes, m, n, o may have been selected and the current diagram may be a nesting of the scale attributes for n within the scale attributes for m. The user is then able to navigate, by selection of a concept in the outer lattice to a concept lattice formed by zooming into that concept and displaying the lattice of o nested inside n.

Further aspects of this invention will become apparent from the following description.

### BRIEF DESCRIPTION OF THE DRAWINGS

FIG. 1 User interface showing an indented list and a concept lattice with Price selected;

FIG. 2 User interface for browsing documents;

FIG. 3 Flowchart representing classification process;

FIG. 4 Cross table for Price attribute;

FIG. 5 Representation of an inverted file index mapping attributes to document numbers;

FIG. 6 Representation of an inverted file index mapping document numbers to attribute numbers;

FIG. 7 Representation of an attribute definition table relating attribute integers to attributes;

FIG. 8 Concept lattice of Price attribute nested with Furnished attribute;

FIG. 9 A concept lattice showing the mid-range, fully furnished concept zoomed and organised in terms of the resource attribute;

FIG. 10 The whole document collection distributed in terms of the Resource attribute;

FIG. 11 A representation of an attribute hierarchy;

FIG. 12 The invention applied to an electronic artefact collection of e-mail documents.

### DETAILED DESCRIPTION OF THE INVENTION

In the context of the current invention, attributes associated with documents can be thought of as folders in which the document exists. In existing classification and retrieval systems, for example Microsoft Windows, an electronic artefact related to Project A would be filed in a folder called Project A which itself may be filed in a folder called Projects. Similarly, for the method and system described herein, an information source is put in a folder by means of associating the document with this folder/attribute which itself may exist in a hierarchy of folders attributes. An advantage the current invention has over the former filing system described above, but not limited to the only advantage, is that an electronic artefact can be associated with one or more attributes and hence can be filed in one or more folders. This process is described in more detail below. Hence, for the purposes of this discussion, the terms attribute, term and folder are used interchangeably with the same intent unless otherwise stated. Addtionally, the terms electronic artefact, information source and document are used interchangeably with the same intent unless otherwise stated.

It is useful to arrange the attributes of a taxonomy into a hierarchy whose meaning is understood by material implication. An implication may be of the form s→t and may be taken to mean: if an electronic artefact is associated with attribute s, then that electronic artefact is also associated with the attribute t.

If an association exists between a collection of documents and a taxonomy of terms arranged in a hierarchy then any subset of documents and attributes may be organized in a concept lattice.

A concept lattice is a lattice of formal concepts, where formal concepts are pairs (A,B) derived from a formal context, (G,M,I) consisting of a set of objects, G, a set of attributes, M, and an association between objects and attributes given by a relation I. A pair (A,B) is a formal concept of the context (G,M,I) if (i) A⊂ B, B⊂ M, A′=B, and B′=A. The derivation of A denoted A′ is defined by;
A′={mεM|(g,m)εI for all gεA} (1)
and the derivation of B denoted B′ is defined by;
B′={gεG|(g,m)εI for all mεB} (2)

The concept lattice of a context, (G,M,I) is denoted B(G,M,I). A diagram of the concept lattice, where the objects are documents and the attributes are folders associated with the document, provides a visual organization of the documents and the attributes under consideration.

The association of documents with folders is made consistent with a partial order defined over the folders which is interpreted via implication. More formally, consider a set of folders, M, organized via a partial order relation, ≦and further consider m,nεM with m≦n. Then interpreting this ordering via implication means that if an electronic artefact g is associated with m then it must also be associated with n because m E n. Each folder has associated with it a set of folders known as the “scale folders” of the folder. These scale folders become the attributes of a concept lattice employed to organize documents with respect to their association with the scale folders. When a user requests that the content of a folder be organized, it is with respect to the scale folders that the documents are organized by the concept lattice.

Documents within a collection are ascribed terms via two mechanisms: (i) a human operator directly associates or disassociates either a single document or a collection of documents with a term (or collection of terms); and (ii) an automatic rule is used to ascribe either a single term or a collection of terms to an electronic artefact or collection of documents based on the content of, or meta-data associated with, the document.

The ascription of terms to documents is used as the basis for retrieving and organizing document collections. Associations and disassociations, made by the user, take precedence over associations and disassociations made according to automatic rules and the result is made consistent with respect to the implication ordering expressed in the taxonomical ordering over the terms.

The association of terms to documents can be modelled as follows. Let the set of documents be denoted G, the set of terms be denoted M, and the hierarchical ordering over terms be denoted ≦with m≦n meaning that any document associated with m should also be associated with n. Further, let U₊ be a binary relation between documents representing the associations made by the user. Likewise let U₋ be a similar relation representing the disassociations made by the user. Let R₊ be a relation representing the automatic associations and R₋ represent automatic disassociations.

Let R^{↑} be the completion of a relation R with respect to the ordering, ≦, and be determined according to Equation 3.
(a,b)εR^{↑}iff∃×εG: (a,x)εR and x≦b (3)

Similarly let R^{↓} be the completion of a relation R with respect to the order, ≦, and be determined according to Equation 4.
(a,b)εR^{↓}iff∃×εG: (a,x)εR and b≦x (4)

The primary relation, combining the associations and disassociations of the user and automatic processes, is determined via Equation 5.
I=((R₊^{↑}\R₋^{↓})∪U₊^{↑})\U₋^{↓} (5)
The relation derived via Equation 5 has disassociations overriding associations and has associations of the user overriding the automatic associations according to rules. A mechanism to provide consistent and scalable modifications to the (i) the hierarchy, (ii) the relations, (iii) the electronic artefact collection and (iv) the attribute collection, is as follows. A change to the attribute hierarchy, (M, ≦), leads to a change to I according to the following method:

If the ordering m<n is inserted into the hierarchy then a set of relationships must be added to R₊^{↑}, R₋^{↓}, U₊^{↑}, and U₋^{↓}. Pairs consisting of (i) documents related by R₊^{↑} to n, and (ii) attributes greater than or equal m must be added to R₊^{↑}. Similarly pairs consisting of (i) documents related by R_{-↓} to n, and (ii) attributes less than or equal to n must be added to R_{-↓}. The relations U₊^{↑} and U₋^{↓} must be updated in a similar fashion. Rather than storing the primary relation I directly, it is instead computed on demand from the stored constituent relations according Equation (5). If the constituent relations are stored as interval compressed inverted indexes then set-minus and union operations become efficient and the indexes do not suffer from being made consistent with the hierarchy.

If the ordering m<n is removed from the hierarchy then a set of relationships must be removed from R_{+↑}, R₋^{↓}, U₊^{↑}, and U_{-↓}. For every pair R₊^{↑} that involves an attribute greater than or equal to m, this pair must be removed unless there is another pair with the same object but an attribute that is less than or equal to m but not less than or equal to n. A similar calculation is required for R_{-↓}, U₊^{↑}, and U₋^{↓}. In order to render the hierarchy as an indented list it is necessary to calculate the covering relation from the ordering relation. An attribute n covers and attribute m if m<n and there is no attribute x with m<x<n. When the hierarchy is modified either by the addition of an ordering or the removal of an ordering the covering relation is also updated. Complex user interface interactions are reduced to a sequence of operations on the hierarchy and the constituent relations. If each operation has an inverse, as for example with insert ordering and remove ordering, then infinite undo's can be supported by running the inverse operations in reverse order of each user interface interaction.

If a relationship (g,m) is inserted into one of the constituent relations R₊, R₋, U₊, and U₋, then the corresponding relation, R₊^{↑}, R_{-↓}, U₊^{↑}, and U_{-↓} respectively will have relationships added. If (g,m) is added to R₊, then, in accordance with Equation 4, any pair involving attribute greater than m and the document g will have to be added to R₊^{↑}. A change to the constituent relationships may arise in the following situations: (i) the user indicates a change to the hierarchy, (ii) the user indicates a change to the user judgements, (iii) the user indicates a change to the query expression of an attribute, (iv) electronic artefacts are either added to, or removed from the collection, and (v) attributes are either added to or removed from the attribute collection. In each of these cases some modification may be required to either the hierarchy or the constituent relations.

Given the primary relation I, between documents and taxonomical attributes it is possible to generate a concept lattice for a subset of the attributes N⊂ M and a subset of the document H⊂ G as given in Equation 6.
B(H, N, I∩(H×N)) (6)

In the case that a concept lattice has a very large number of objects, yet a small number of object intents (subsets of attributes that can be expressed as g′ where gεG), a large efficiency can be gained by calculating the concept lattice from the set of object intents. Such a context is called the object clarified context of a context (G,M,I) defined as:
({g′|gεG}, M, ) (7)
where g′ is calculated with respect to the incidence relation I.

A binary relation R between documents and attributes may be stored using two inverted file indexes. Optionally, a knowledge base or a relational database may be used to store relations between documents.

In an inverted file index, both documents and attributes are represented via integers, which may in turn be used to locate text descriptions or textual references for the document or attribute. The inverted file index stores a sequence of document integers for each attribute integer. The sequence for an attribute may be compressed, and stored, in order, the integers of every document that is associated via the relation with the attribute. An index is stored from the attributes to the documents, and also from the documents to the attributes.

Given an inverted file index for the primary relation I it is possible to generate the object clarified context of the context defined in Equation 6 using Algorithm 1. The algorithm iterates through the documents associated with each term mεN collecting intents and storing them (as well as their size).

```
function generate_derived_context(R: relation, M_s: set)
  return map<set,integer>
  begin
  S := { set_iterator(R.extent(m)) | m ∈ M_s }
  expired := { s ∈ S | s.at_end( ) }
  avail := S \ expired
  while avail ≠ emptyset loop
  min := min_{s ∈ avail} s.val
  T := { s in S | s.val = min }
  result[T] := result[T] + 1
  for s in T loop
    s.next
  end
  expired := { s ∈ S | s.at_end( ) }
  avail := S \ expired
end
end
```

Algorithm 1: Simple Algorithm to Determine an Object Clarified Context.

In the case that some attributes are associated with a large proportion of the documents, as is the case when the attributes are arranged in a hierarchy, the interval algorithm (Algorithm 2), becomes more efficient as the size of the intervals that it handles increases and the number of intervals it must consider decreases.

An improvement of Algorithm 1 is given in Algorithm 2. This algorithm considers internals of documents having each of the attributes and determines object intents by intersecting the intervals.

```
function generate_derived_context(R: relation, M_s: set)
  return map<set,integer>
  local
  avail: set<set_iterator>
  expired: set<set_iterator>
  m: interval
  begin
  S := { set_iterator(R.extent(m)) | m ∈ M_s }
  expired := { s ∈ S | s.at_end( ) }
  avail := S \ expired
  while avail ≠ emptyset loop
    m.begin := min_{ s ∈ avail } s.val.begin
    m.end := min_{ s ∈ avail } s.val.end
    for s ∈ avail do
    if s. begin − 1 ∈ [m.begin,m.end] then
    m.end := s.begin − 1
    end
  end
  T := { s ∈ S | s.val ∩ m ≠ emptyset }
  result[T] = result[T] + (min.end − min.begin) + 1
  for s ∈ T loop
    s.next_gte(min.end+1)
  end
  expired := { s ∈ S | s.at_end( ) }
  avail := S \ expired
  end
end
```

Algorithm 2: Interval Algorithm to Determine a Clarified Context.

Both algorithms have been simplified by excluding details of incremental computation of their variables. Rather, during each iteration, the variables min, avail, expired and T are calculated from their definitions. In practice these variables are calculated incrementally making use of data structures including, but not limited to, binomial heaps.

Both algorithms compute and return a map that gives the cardinality of each object intent of the original context. These object intents form the objects of the clarified context from which a concept lattice is derived. The algorithms are expressed assuming a number of entity types that will now be briefly explained:
1. A relation is an entity from which it is possible to extract, for each attribute m, a set iterator that ranges over the objects, g related to m. Typically such functionality is facilitated by an inverted file index.
2. A set iterator is an entity which may be employed to enumerate the elements of a sequence. When returned from the function R.extent(m) the sequence enumerated is that provided by a lexical ordering of objects related to m by R. In the first algorithm (Algorithm 1), the operation s.val returns an element of the sequence. In the second algorithm (Algorithm 2), the operation s.val) returns an interval [a,b]. The operation s.next used in the first algorithm advances the iterator to the next element of the sequence, while s. next_gte(x) modifies the interval returned by s.val to be largest interval containing elements from s, no elements lexically smaller than x, and containing the lexically smallest element larger than or equal to x.

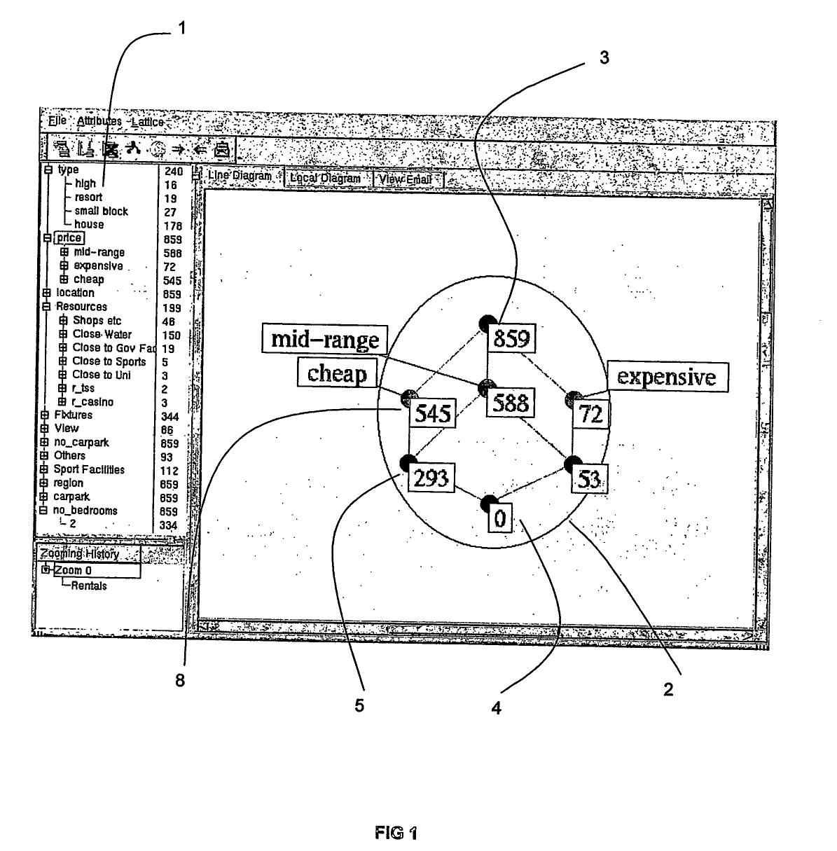

FIG. 1 contains a user interface containing an indented list 1 and a concept lattice 2. The indented list interface components, similar in appearance to that found in Microsoft Windows File Explorer, contains a list of folders. Unlike most other indented list interface components, the component in FIG. 1 displays the covering relation derived from a partial order defined on the folders. Modelled formally, a partial order is a set of elements, P and a partial order relation, ≦defined over P which is (i) reflexive, (ii) transitive, and (iii) anti-symmetric. A covering relation, [symbol] defined over P is derived from the partial order relation via the definition:
x [symbol] y iff x≠y and ∀zεP:x≦z≦y implies z=x or z=y.

A tree is derived from the partial order by collecting the empty path ε together with the set of all paths (x₁, . . . ,xₙ) where xₗ [symbol] xᵢ₊₁ for i in 1, . . . ,n−1, x₁ εtop(P) and n≧1. The parent relation for the tree is given by the rule (x₁, . . . ,xₙ₋₁) is a parent of (x₁, . . . ,xₙ). The indented list interface provides, but is not limited to, the following operations:
1. Unfold folder. The children of the element selected are added to the diagram.
2. Fold folder. The children of the element selected are removed from the diagram.
3. Add ordering(s). An ordering is introduced between a set of selected element and another set. This operation modifies the partial order defined over the folders.
4. Remove ordering(s). An ordering is removed between one set of selected elements and another set. This operation modifies the partial order defined over the folders.
5. Move ordering(s). This operation invokes removing the ordering between two elements and introducing an ordering from one of those elements to a third element.
6. Add folder(s). A new folder is created. An ordering may be introduced in the creation operation between the newly created folder and an existing folder or set of folders.
7. Remove folder(s). A collection of folders is removed both from the ordering and the set of folders.

The concept lattice displayed may be modified by, but is not limited to modification by, the following operations:
1. Zoom to concept. The current zoom context is amended to include the intent of the selected concept.
2. Zoom to attribute. The current zoom context is amened to include the selected folder.
3. Display folder. The scale associated with the selected folder is displayed.
4. Nest folder. The scale associated with the selected folder is nested with a currently displayed scale.
5. Navigate from concept to documents. The documents in the extent of the selected concept are displayed in a list to the user from which they may browse each document.
6. Navigate from folder to documents. The document, in the extent of the selected folder, are displayed in a list to the user from which they may browse each document.

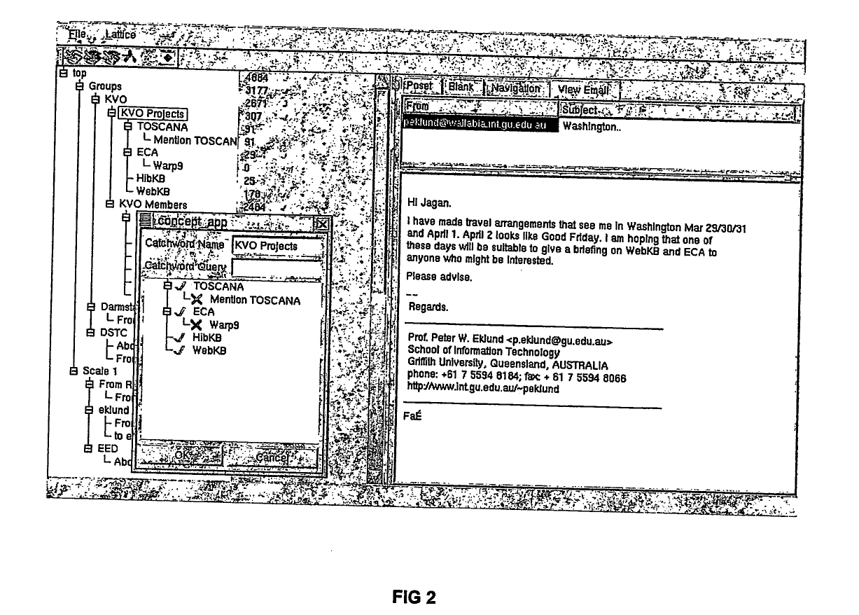

When the operator navigates to documents the documents may be displayed as shown in FIG. 2. In this view a summary of the documents is presented in the form of a list. The operator may select one or more documents. One of the documents from the list may be displayed in detail in the area below the list. The indented list view for the folders is again shown on the left.

The following operations are provided. The selected documents may be inferred by the selection of a concept in a concept lattice in which case the documents are taken to be the document extent.
1. Associate documents with folders. The selected documents are marked as being associated with the selected folders.
2. Disassociate document with folder. The selected documents are marked as not being associated with the selected folders.
3. Remove document judgments. The selected documents are marked has having neither an association nor a disassociation with the selected folders.

When documents are selected, whether or not all or some selected documents are associated, or disassociated with each displayed folder may be indicated to the operator. Similarly, when folders are selected their association state with respect to displayed documents may be indicated to the operator.

This user interface constituted by the combination and coordination of the folder view and the document view enables a process whereby the user is able to organize documents to be processed thematically and also to retrieve documents thematically.

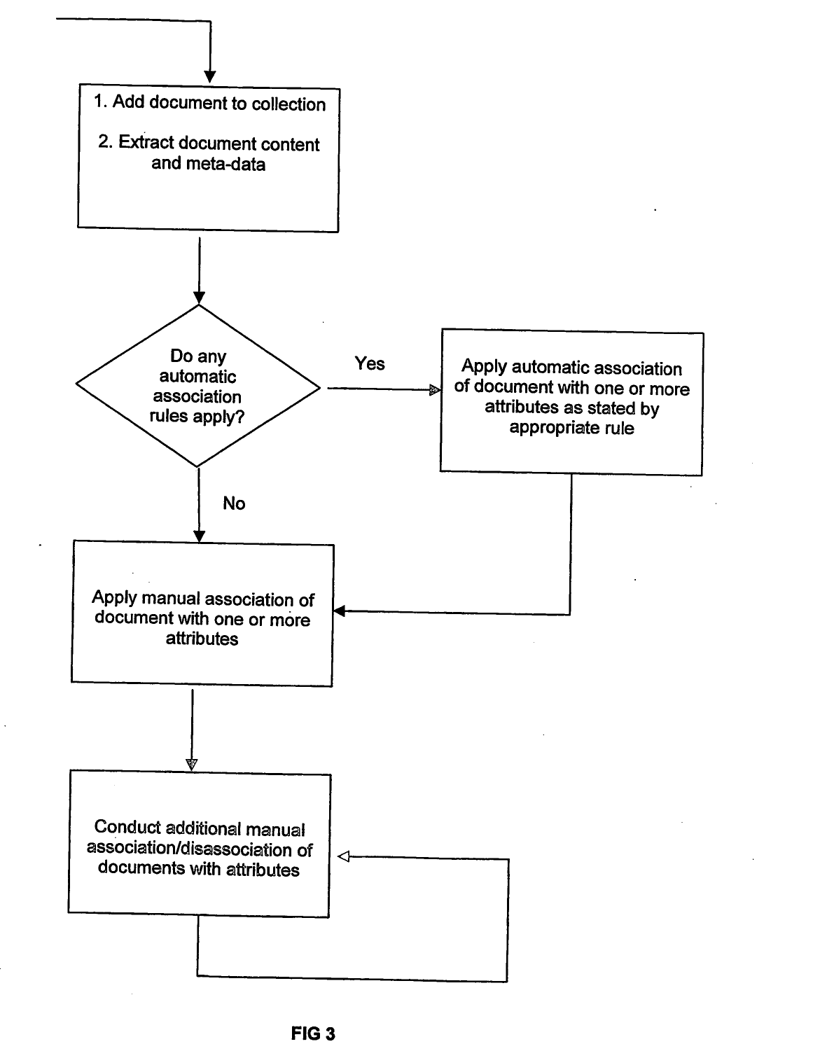

With reference to FIG. 3, the classification method commences when a new document enters the system. If there are one or more automatic association rules relevant to the document then attributes are associated to this document in a manner that conforms to these rules.

An example of when automatic association of documents with folders may occur is when classification and retrieval of real estate rental advertisement documents is taking place. It should be obvious to a person skilled in the prior art that the system and method described herein can be applied to any information classification and retrieval application and is not restricted to the application described in the rental example referred to below.

In the example, referred to throughout this discussion information sources are the electronic documents containing the rental advertisements and the attributes are features of the item of real estate for rent. There may exist the attribute Price in the system detailing the price of the item of real estate as described by the document entering the system.

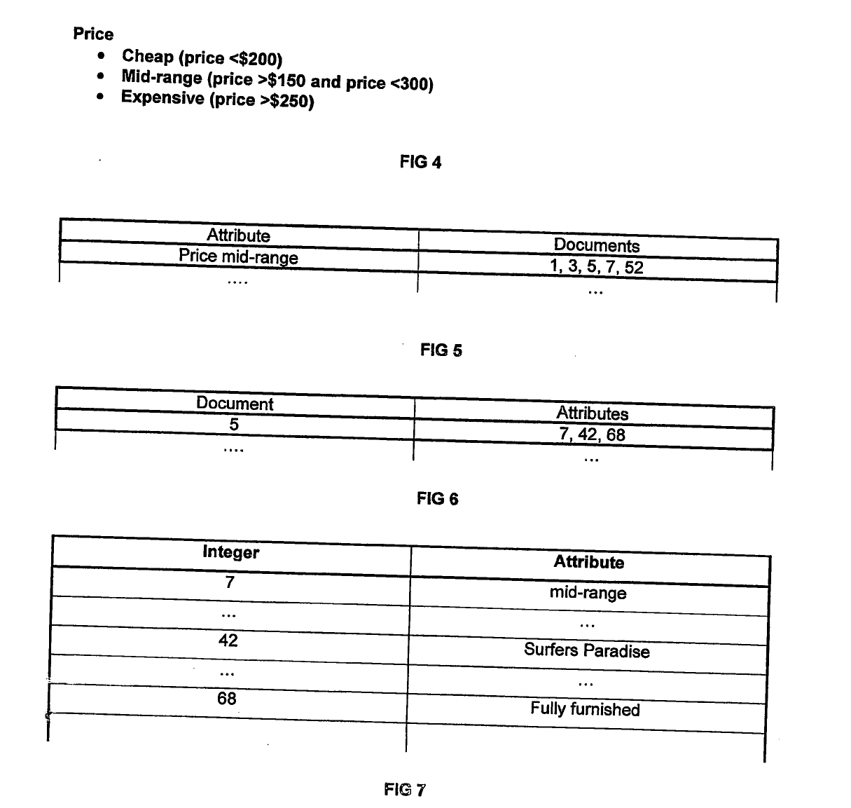

As previously discussed, the present invention allows attributes to have one or more scale attributes associated with them. These scale attributes further classify an electronic artefact put in an attributes folder and it is with respect to the scale attributes that documents are organized into concept lattices as detailed later in this discussion. The scale attributes that are associated with the Price attribute—namely cheap, mid-range and expensive—of the rental document are shown in FIG. 4. Each scale attribute is shown with a query expression used to derive document attribute associations. The default scale definition for an attribute is the set of immediate specialisations within the attribute hierarchy. Thus it is convenient, in this case, to arrange the attribute hierarchy so that the immediate specialisations are precisely the scale attributes.

Referring to FIG. 4, a rental property that has a price of $175 will be associated with the scale attribute of cheap as well as that of mid-range. Hence, this rental advertisement document would be associated, by means of pre-defined automatic rules in the system, to the cheap and mid-range scale attributes of Price.

Referring again to FIG. 3, it can be seen that the automatic association of attributes to documents can be removed at any stage manually. Hence, if the rental price of a particular advertisement document is changed at any stage, or if the user has detected an incorrect association of attributes with documents, the attribute can be disassociated with the information source manually. Rules concerning the associations and disassociations of documents with attributes have been discussed in detail above.

The process of storing the relationship between documents and attributes can be done using any appropriate data structure including two-dimensional arrays, hash tables or map data structures. The preferred approach, since it is efficient and scalable, is to use an inverted file index with a hash-table implementation but it would be clear to a person skilled in the prior art that this process is not limited to this data structure and is determined by the quantity of the electronic artefacts being processed.

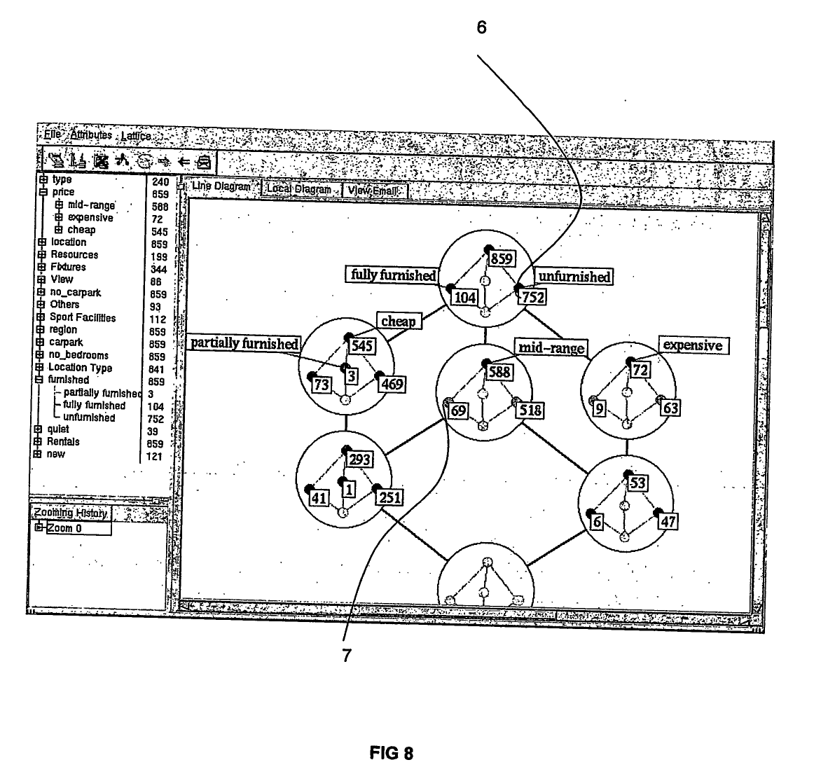

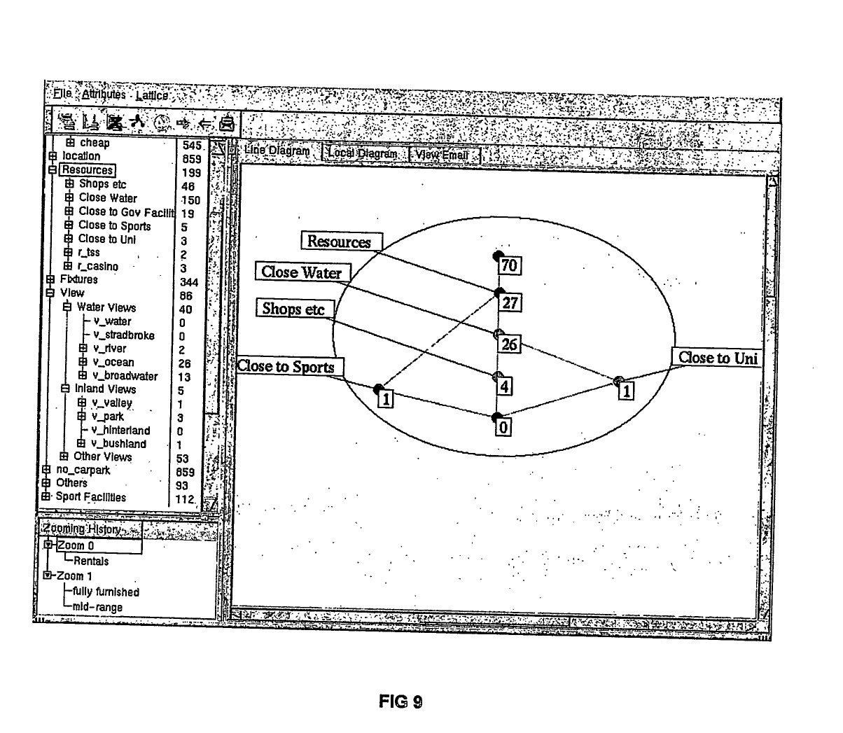

In a preferred embodiment, the relation between documents and attributes may be stored using two inverted file indexes as discussed previously. FIG. 5 shows a representation of an inverted file index that stores documents associated with each identified attribute. In this case, the document numbers are shown that relate to the attribute mid-range, which is a scale attribute of the Price folder. FIG. 6 shows a representation of an inverted file index that stores attribute numbers associated with documents. In this case, the attribute numbers are shown that relate to document 5. These attribute numbers are translated to attributes by the system in an appropriate way, the implementation of which is not an essential feature of the invention and would be obvious to a person skilled in the art. Similarly, document numbers are associated with the location of documents within the system, the implementation of which is not an essential feature of the invention. Continuing the real estate example, a table is provided in FIG. 7 that provides a representation of attribute number to attribute mappings.

It can be seen from the example in FIG. 6 that documents can be related to one or more attributes. Consequently, documents exist in multiple positions within a classification hierarchy, which represents a significant advantage over the Microsoft Windows classification and retrieval system mentioned in the background section.

FIG. 11 represents a portion of an attribute hierarchy as it relates to rental document 5. Hence, this particular rental property is classified in terms of the attributes location, price and furnishings and the document exists in all three parts of this rental hierarchy. In terms of the hierarchy of folders represented in the indented list in FIG. 11, it can be seen that an electronic artefact that is associated with the folder/attribute Surfers Paradise implies it is also associated with the central and regional attributes.

Further, it is possible for an electronic artefact to exist in one or more different scale attributes associated with one scale. For example, referring to FIG. 4 again, a rental price of $175 is associated with scale attributes cheap and mid-range respectively. Hence, this rental property document would exist within the domain of both of these scale attributes of Price.

It should be clear that the electronic artefact does not actually exist in one or more places within the hierarchy, meaning that several copies of this electronic artefact exist within the information classification and retrieval system. Rather, only one electronic artefact exists and the file system represents the fact that the electronic artefact is referenced from one or more attributes in the inverted file index by indicating that it is related to one or more attributes in the hierarchy.

Manual classification of an information source can take place at any time the information source is in the system as indicated in FIG. 3. Once classification has taken place, representation and retrieval of information can be undertaken.

The method for retrieval of information begins with the user adding one or more attributes to constrain the information collection initially. When considering the real estate rental example of above, the user may wish to represent all rental advertisement documents in the collection in terms of the attribute Price. Referring to FIG. 1, this information is represented in a line diagram representation of a concept lattice 2.

Referring again to FIG. 1, the rental real estate advertisement documents are represented in the context of price are distributed in terms of the scale attributes of price which are cheap, mid-range and expensive in a concept lattice. It can be seen that the concept associated with 8 indicates a concept that has as its intent the scale attribute of price, cheap, and has as its extent, 545 rental advertisement documents.

Hence, concept 8 indicates to a user that there are 545 rental advertisements stored in the system that are cheap whereas concept 5 indicates to a user that there are 293 rental advertisements stored in the system that are classified as both cheap and mid-range. It is clear from the display of FIG. 1 that the system of the present invention offers the user with a display that is richer in information that can be easily interpreted than prior art information classification and retrieval systems.

The top circle in a nested line-diagram representation of a concept lattice is the most general concept. In FIG. 1, the top circle 3 represents the 859 concepts that are associated with the price attribute without any additional specialisation. The bottom circle 4 in a nested line-diagram is the most specific concept in the concept lattice which in FIG. 1 is the concept that has all three scale attributes of price as part of its intent. This concept has no rental advertisement document associated with it as there are no documents that have been classified as being cheap, mid-range and expensive.

The concept lattice of FIG. 1 highlights the fact that an information source may be associated with more than one scale attribute as discussed above. Concept 5 is the intersection of cheap and mid-range properties and has, as a subset of its extent, 293 documents, and as a subset of its intent, the set of attributes {cheap, mid-range}.

While the document collection of rental advertisements has been organised in terms of Price in FIG. 1, the user may wish to add more information to the concept lattice by combining it with a scale specifying whether or not a property is furnished. The furnished attribute has the scale attributes furnished, partly furnished and unfurnished. These scale attributes are a means by which the rental advertisement documents are organised within the furnished folder.

The implementation of the present invention generates a new lattice based on the combined scales as defined by the user and this process is called nesting. FIG. 8 combines the price scale with a scale for furnished, using a nested line-diagram. The structure of the price lattice has been maintained by the larger circles and each of these circles have been organised in terms of the furnished attribute.

Nested line-diagrams are interpreted in the same way as normal line-diagrams as detailed above. Referring to FIG. 8, circle 6 indicates the concept containing rental advertisements of all price ranges, as it is the top concept in the price concept lattice, that are unfurnished. Hence, it can be seen that there are 752 concepts that are unfurnished of any price range. Similarly, circle 7 indicates that there are 69 concepts that are priced in the mid-range price and are fully furnished.

The user may be particularly interested in finding rental advertisements describing properties that are priced in the mid-range and are fully furnished and hence selects this concept as shown by circle 7 in FIG. 8. This process of selecting a particular concept in a lattice is called zooming. When zooming occurs the document collection is further constrained to only include documents that have the intent of the selected concept as a subset of their intents. Similarly, the zoom operation restricts the objects shown in the lattice to only those in the extent of the selected concept.

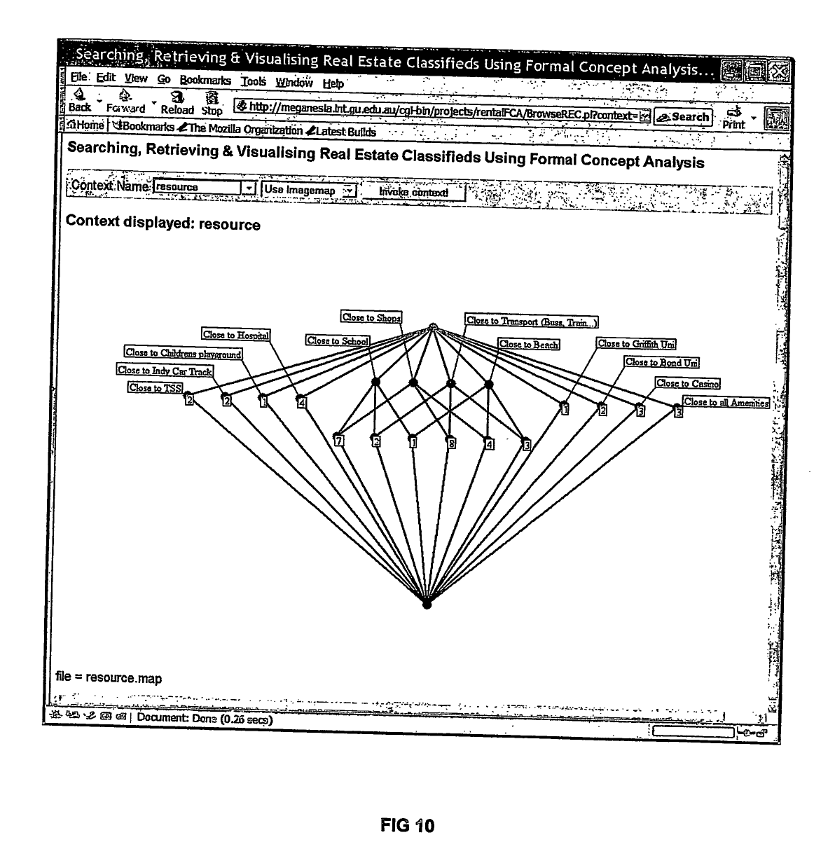

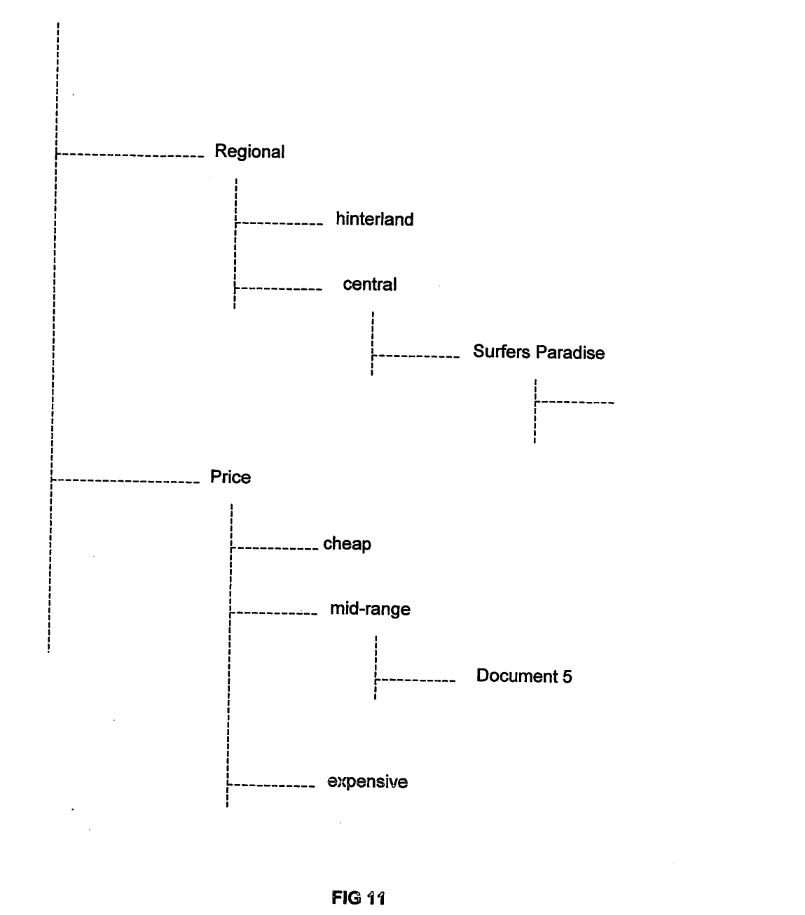

FIG. 9 shows the scale of FIG. 8 zoomed in on concept 7 organized further with a resources attribute added to the lattice. The resources attribute is organised using the scale attributes near shops, near water, etc. The scale attributes for the resource attribute applied to the whole document collection can be seen in the concept lattice in FIG. 10. It can be seen when referring to FIG. 9 and FIG. 10 that the concept lattices have a different structure. This is due to the fact that the concept lattice contains only the 69 real estate rental documents that the user is interested in on the concept lattice of FIG. 9 as the zooming operation has restricted the object set to the extent of the concept for fully furnished and mid-range attributes and hence only displays the intents of these documents with regards to the resource attribute. The concept lattice of FIG. 10 represents the entire document collection and contains the intents of the entire collection in regards to the resource attribute.

Referring again to FIG. 9, the user can determine from the lattice that proximity to shops implies proximity to water. Further, it can be seen that it is impossible to satisfy a desire to be close to University and close to shops in this restricted set of rental documents.

The user is now able to make a decision between different attributes that are represented in the lattice of FIG. 9. Optionally, the user can zoom in further on one concept or alternatively there is the capacity to remove the current zoom and move back to the scale as shown in FIG. 8. Further, there is the capacity to include another scale to the concept lattice shown in FIG. 9 to constrain the document collection to a smaller subset based on desirable attributes.

It should be clear to a person skilled in the art that, in the example detailed above, if the attribute furnished was first selected and then the price attribute was nested within the furnished attribute, the concept lattice would have a different structure and presents the user with subtly different information, particularly in the top concept of the large circles in the line-diagram representation.

The information classification and retrieval system of the present invention dynamically generates the concept lattices based on the attribute values selected by the user.

The key difference between the current invention and the prior art, referring again to the real-estate example, is that prior classification and retrieval systems and methods would be asked a question like “list all mid-range houses that are close to the city, have a view, are close to the park, close to shops and close to transport?” and the system would return a long list of properties, or none at all. The current invention, based on formal concept analysis and concept lattices allows questions like “what are the possibilities for a mid-range house, close to the city, with a view, maybe close to a park, shops or transport?” and the user is able to discriminate the important attributes as they relate to the collection at that moment, relaxing or enforcing attribute search constraints depending on the volume of data that exists for each interacting attribute. This is a clear and distinct advantage of the information classification system and method over prior art systems.

Another significant advantage of the present invention over the systems and methods proposed in prior art is that the system is scalable, meaning that efficient retrieval of electronic artefacts is possible as the system scales to larger electronic artefact collections. This feature is due to the generation of concept lattices from inverted file indexes by means of the algorithms listed above.

While the invention has been described above in terms of a rental document collection, it should be obvious to a person skilled in the prior art that this system and method can be readily employed to any application in which classification and retrieval of electronic artefacts, including many different forms and types of electronic documents, is necessary.

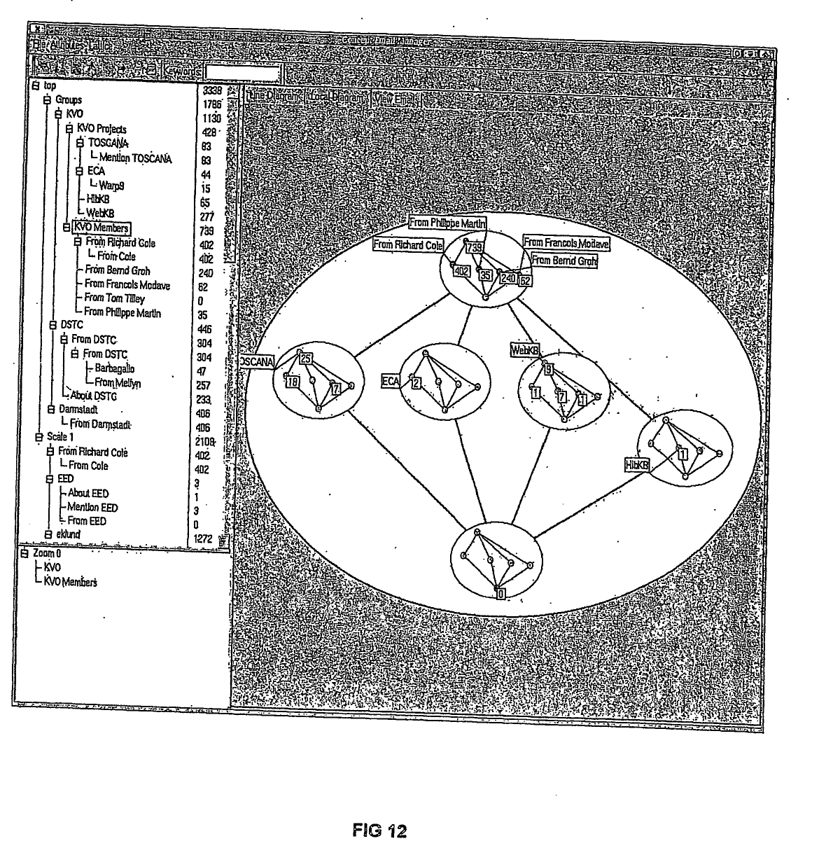

For example, the screen shot of FIG. 12 shows email documents represented in a concept lattice according to the invention. It will be appreciated that the invention can interface with common e-mail programs to automatically store e-mail documents in folders which can be retrieved by searching using multiple attributes which are displayed in concept lattices as shown on the right side of FIG. 12. Other applications will be evident to persons skilled in the art.

It will be appreciated that the invention provides an effective means of graphically displaying attribute relations in a large taxonomy of information sources (on the electronic artefacts sharing common attributes) in a manner that permits scaling to virtually any number of information sources.

1. An information classification and retrieval system comprising:
(a) a collection of one or more electronic artefacts;
(b) a collection of one or more attributes, said attributes arranged in a hierarchy;
(c) a collection of one or more relations, each said relation providing an association between an electronic artefact and an attribute;
(d) a modification mechanism to modify one or more of:
(i) said hierarchy;
(ii) said one of more relations;
(iii) said collection of one or more electronic artefacts; and
(iv) said collection of one or more attributes;
(e) a display mechanism for dynamically constructing and displaying a concept lattice, said concept lattice comprising an arrangement of at least one said electronic artefact, at least one said attribute and at least one said relation.

2. An information classification and retrieval system according to claim 1 wherein each said electronic artefact is associated with one or more said attributes by one or more said relations.

3. An information classification and retrieval system according to claim 1 wherein each said attribute is associated with one or more said electronic artefacts by one or more said relations.

4. An information classification and retrieval system according to claim 1 wherein said hierarchy provides for a partial ordering of said attributes in said system such that if there exists a first attribute s and a second attribute t in said system such that s≦t, then each said electronic artefact located in said system that is associated with said attribute s via a relation is also associated with said attribute t via a relation.

5. An information classification and retrieval system according to claim 1 wherein each said relation is derived from one of:
i. a positive association made by a user between said electronic artefacts and said attributes;
ii. a disassociation made by a user between said electronic artefacts and said attributes;
iii. a positive association between said electronic artefacts and said attributes computed dynamically by said system based on rules stored in said system; and
iv. a disassociation between said electronic artefacts and said attributes as computed dynamically by said system based on rules stored in said system.

6. An information classification and retrieval system according to claim 5 further comprising a primary relation, said primary relation being derived from one or more said relations.

7. An information classification and retrieval system according to claim 6 wherein the modification mechanism provides consistent and scaleable modifications to one or more of:
i. said hierarchy of attributes;
ii. one or more said relations;
iii. one or more said electronic attributes;
iv. one or more said attributes; and
v. said primary relation.

8. An information classification and retrieval system according to claim 7 wherein said modification mechanism modifies said primary relation based on the following formula:
I=((R₊^{↑}\R_{-↓})∪U₊^{↑})\U_{-↓}
wherein I represent the primary relation, R₊^{↑} represents said positive associations computed by said system, R₋^{↓} represents said negative associations computed by said system, U₊^{↑} represents said positive associations made by a user and U_{-↓} represents said positive associations made by a user.

9. An information classification and retrieval system according to claim 7 wherein said modification mechanism undertakes said modifications based on one of the following:
i. a user modifies said hierarchy;
ii. a user changes said association made by said user between said electronic artefacts and said attributes;
iii. a user changes said disassociations made by said user between said electronic artefacts and said attributes;
iv. an electronic artefact is added to said collection of electronic artefacts;
v. an electronic artefact is removed from said collection of electronic;
vi. an attribute is added to said attribute collection; or
vii. an attribute is removed from said attribute collection.

10. An information classification and retrieval system according to claim 1 wherein said electronic artefacts are text documents in the system and said attributes are electronic folders, each said text document being related to one or more said attributes based on content and/or metadata of each said document.

11. An information classification and retrieval system according to claim 1 wherein one or more scale attributes are associated with each said attribute in said attribute collection.

12. An information classification and retrieval system according to claim 11 wherein said scale attributes are displayed in said concept lattice by said display mechanism.

13. An information classification and retrieval system according to claim 1 wherein said display mechanism generates and displays said concept lattice based on one or more query attributes provided by a user.

14. An information classification and retrieval system according to claim 13 wherein said electronic artefacts displayed in said concept lattice are related to at least one query attribute.

15. An information classification and retrieval system according to claim 1 wherein said concept lattice is displayed by said display mechanism in the form of a line diagram.

16. An information classification and retrieval system according to claim 1 wherein said concept lattice is displayed by said display mechanism in the form of a nested line diagram when two or more attributes comprise said concept lattice.

17. An information classification and retrieval system according to claim 1 wherein said relations between said electronic artefacts and said attributes are stored on a computer readable medium located in said system using a knowledge base.

18. An information classification and retrieval system according to claim 1 wherein said relations between said electronic artefacts and said attributes are stored on a computer readable medium located in said system using a relational database.

19. An information classification and retrieval system according to claim 1 wherein said relations between said electronic artefacts and said attributes are stored on a computer readable medium located in said system using an inverted file index.

20. An information classification and retrieval system according to claim 19 wherein an inverted file index stores a reference to all said electronic artefacts associated by a relation with each said attribute.

21. An information classification and retrieval system according to claim 19 wherein an inverted file index stores a reference to all said attributes associated by a relation with each said electronic artefact.

22. An information classification and retrieval system according to claim 19 wherein said inverted file index is an interval compressed inverted file index.

23. An information classification and retrieval system according to claim 19 wherein said inverted file index is implemented in the form of a hash table.

24. An information classification and retrieval system according to claim 1 wherein said concept lattice is comprised of one or more concepts, each said concept comprising at least one said electronic artefact, at least one said attribute and relations between said electronic artefacts and said attributes.

25. An information classification and retrieval system according to claim 24 wherein each said concept in said concept lattice is selectable by a user to prompt said display mechanism to dynamically construct and display a second concept lattice, said second concept lattice comprising only electronic artefacts forming part of said selected concept.

26. An information classification and retrieval system according to claim 24 where each said electronic artefact displayed in said concept lattice is displayable based on an input from a user.

27. An information classification and retrieval system comprising:
(a) a collection of one or more electronic artefacts;
(b) a collection of one or more attributes, said attributes arranged in a hierarchy;
(c) a collection of one or more relations, each said relation providing an association between an electronic artefact and an attribute; and
(d) a display mechanism for dynamically constructing and displaying a concept lattice, said concept lattice comprising an arrangement of at least one said electronic artefact, at least one said attribute and at least one said relation.

28. An information classification and retrieval system comprising a concept lattice.

29. A method in a computer system of classifying and retrieving information in an information store wherein said information is displayed in a concept lattice.

30. A method in a computer system of classifying and retrieving information including the steps of:
i. adding an electronic artefact to an electronic artefact collection stored in said computer system;
ii. determining whether there are one or more automatic association rules stored in said system that relate said electronic artefact to one or more attributes forming part of an attribute collection stored in said system and, if so, creating one or more relations that associate said electronic artefact with one or more said attributes as determined by said one or more automatic association rules;
iii. storing said relations created in step (ii); and
iv. displaying a subset of said electronic artefacts stored in said electronic artefact collection in a concept lattice, all said electronic artefacts displayed in said concept lattice being associated by at least one relation to at least one attribute determined by a user.

31. A method in a computer system of classifying and retrieving information according to claim 30 further including the step of creating one or more relations associating said electronic artefact with one or more said attributes based upon input from a user.

32. A method in a computer system of classifying and retrieving information according to claim 30 or claim 31 further including the step of removing one or more relations created.

33. A method in a computer system of classifying and retrieving information according to claim 30 wherein each said electronic artefact is associated with one or more attributes by one or more relations.

34. A method in a computer system of classifying and retrieving information according to claim 30 wherein each said attribute is associated with one or more electronic artefacts by one or more relations.

35. A method in a computer system of classifying and retrieving information according to claim 30 wherein said concept lattice is comprised of one or more concepts, each said concept having at least one said electronic artefact, at least one said attribute and relations between said electronic artefacts and said attributes.

36. A method in a computer system of classifying and retrieving information according to claim 35 further including the steps of:
a user selecting a concept in said concept lattice;
displaying a second concept lattice, said second concept lattice comprising only electronic artefacts forming part of said selected concept.

37. A method in a computer system of classifying and retrieving information according to claim 30 further including the steps of
a user selecting an electronic artefact displayed in said concept lattice; and
displaying information forming part of said selected electronic artefact.

38. A method in a computer system of classifying and retrieving information according to claim 30 further including the steps of:
a user adding one or more further attributes to said concept lattice; and
displaying a second concept lattice having all said electronic artefacts associated by relations to said attributes and said one or more further attributes.

39. An information classification and retrieval system as described herein with reference to the accompanying figures.

40. A method in a computer system of classifying and retrieving information as described herein with reference to the accompanying figures.
